(19) United States
(12) Patent Application Publication
(10) Pub. No.: US 2006/0231498 A1
(43) Pub. Date: Oct. 19, 2006

(54) Reactive filtration

(76) Inventors: Brian Hart, Moscow, ID (US); Gregory Moller, Moscow, ID (US)

Correspondence Address: Ormiston & McKinney, PLLC;Suite 400, 802 W. Bannock, P.O. Box 298, Boise, ID, 83701-0298, US

(21) Appl. No.: 11/403,648

(22) Filed: Apr. 13, 2006

Related U.S. Application Data
(60) Provisional application No. 60/671,347, filed on Apr. 13, 2005.

(51) Int. Cl. C02F 1/52

(52) U.S. Cl. 210/722; 210/724

(57) ABSTRACT

In one embodiment, a method for removing a contaminant from alkaline water includes adding ferric iron to alkaline water until reaching a pH less than 7 to form a neutralized solution and exposing the neutralized solution to iron metal.

### CROSS REFERENCE TO RELATED APPLICATION

This application claims subject matter disclosed in co-pending provisional patent application Ser. No. 60/671,347 filed Apr. 13, 2005, entitled Reactive Filtration.

### STATEMENT OF RIGHTS TO INVENTIONS MADE UNDER FEDERALLY FUNDED RESEARCH AND DEVELOPMENT

Part of the work performed during the development of embodiments of the invention was funded by the United States Environmental Protection Agency under contract no. X970339010. The United States government may have certain rights in the invention.

### BACKGROUND

Metal hydroxides, formed at alkaline pH, precipitate from solution due to low solubility product constants, Kₛₚ (e.g., [M²⁺(OH⁻)₂]). This characteristic is exploited in conventional water treatment by a base, such as lime, to remove metals such as copper, zinc, cadmium and lead from solution as hydroxide precipitates. However, highly alkaline waters, typically with pH>10, can allow for charged metal polyhydroxide formation, resulting in soluble metal hydroxides (e.g., [M²⁺(OH⁻)₂]OH⁻). In conventional water treatment, such polyhydroxide formation may be managed by adding acid to lower pH below the level allowing metal polyhydroxide formation. Also, some neutral metal hydroxide species may stay in solution as aqueous neutrals or as “charged clusters” from molecular level interactions of insoluble metal hydroxides with shells of H₂O and OH⁻ or other anionic species such as sulfate.

### DETAILED DESCRIPTION

Embodiments of the invention were developed in an effort to more effectively remove selenium and heavy metals from alkaline water. Consequently, embodiments are described for the removal of selenium. Embodiments of the invention, however, are not limited to the removal of selenium or heavy metals but may be used to remove other contaminants.

Many alkaline waters from natural, agricultural or industrial sources are simultaneously contaminated with selenium, a sulfur analogue, typically in the soluble form selenate, with oxidized Se(VI). Often these waters are highly dissolved solids, often as sulfate salt solutions. Acidification usually has little or no effect on the solubility of selenium in these solutions, but some removal may be observed in high dissolved solids waters due to co-mineralization with the precipitating metal hydroxides.

Added ferric iron solution competes for hydroxide in highly alkaline metal laden solutions. Metal ions with lower Kₛₚ, however, will out-compete iron ions for hydroxide. In alkaline solutions, excess hydroxide allows for reaction with added iron salts. Spontaneous formation of iron oxyhydroxide floc occurs and this precipitate continues to form as ferric iron is added, removing available hydroxide. In this part of the process, one mole of ferric iron, Fe³⁺, can react with three moles of hydroxide, OH⁻, decreasing solution alkalinity. The precipitating floc is efficient in assisting the clearance of precipitated heavy metal hydroxides. In addition, sulfate and selenate oxyanions can be incorporated into precipitating mineral solids, such as green rusts, as well as sorbing onto precipitating iron oxyhydroxide floc.

At neutral pH, ferric iron salts can continue to react by hydrolyzing water and increasing acidity and dropping pH.
[Fe(H₂O)₆]³⁺+H₂O→[Fe(H₂O)₅(OH)]²⁺+H₃O⁺K=10^{-3.05}
[Fe(OH)(H₂O)₅]²⁺+H₂O→[Fe(OH)₂(H₂O) ₄]⁺+H₃O³⁰ K=10^{-3.26}
2[Fe(H₂O)₆]³⁺+2H_{H}₂O→[Fe₂(OH)₂(H₂O)₈]⁴⁺+2H₃O⁺K=10^{-2.91}
This is advantageous to selenium removal which occurs most readily at pH<7. Acidic solutions are also more reactive to iron metal (Fe⁰) enhancing their corrosive dissolution. Applying a solution of acidic, ferric iron onto solid iron metal allows reaction at the iron surface via the hydrolysis of water and the concomitant production of hydronium ions with a strong reducing environment capable of reducing selenium oxyanions.
Fe^{0b +2}H₃O±→Fe²⁺+H₂+H₂O E⁰_{red}=−0.44V

This reaction is a favorable reaction for the removal of dissolved selenium since it allows the simultaneous reduction of ferric iron and selenium oxyanions. Se(VI) is typically not very reactive to co-precipitation reactions whereas Se(IV) is highly reactive in co-precipitation reactions with iron salts. Iron metal can reduce Se(VI) to Se(IV) and Se(O). Se(IV) as the oxyanion selenite reacts with ferrous/ferric iron to form iron selenite minerals that co-precipitate. Se(O) is an insoluble solid that can also be physically separated. Reduction of selenium by iron metal appears to be better at slightly acidic pH, nominally pH=5. Continuous iron oxyhydroxide floc formation assists in the sorptive removal of precipitated mineralized compounds, including selenium compounds and heavy metal precipitates.

In a continuous flow embodiment, the process includes: adding ferric iron to a flowing solution to a 10>pH>7; separating reaction solids by, for example, separating or clarifying; adding ferric iron to a flowing solution to a 7>pH>3, preferably about 6.5>pH>5; and flowing mixed solution through a column of iron metal granules (or powder) or a mixture of sand and iron metal granules. A moving bed filter sand/iron mixture of 10% to 50% by volume iron, for example, provides a suitable filter/reaction medium. U.S. patent application Ser. No. 10/727,963 filed Dec. 3, 2003 describes reactive filtration apparatus, materials and processes that can be used to implement a continuous flow process such as the one described above. The disclosure in application Ser. No. 10/727,963 is, therefore, incorporated herein by reference in its entirety.

In a batch processing embodiment, the process includes: adding ferric iron to a solution with mixing; separating precipitated solids; adding iron metal with mixing; and precipitating solids and non-reacted iron metal.

The disclosed processes allow for removal of heavy metals, modification of pH to circum-neutral, and removal of selenium in water. Heavy metals may be sequestered as iron hydroxyoxide sorbed minerals, rendering the metals less hazardous.

### EXAMPLE NO. 1

A solid cement sample was mixed with water to make five gallons of supernatant with a pH =12.7 and a total selenium concentration of 5.8 mg/L. Speciation of the sample showed that it contained 70% selenate (Se(VI)) and 30% selenite (Se(IV)). FeCI₃ was added until reaching pH =8.4, producing a large amount of floc and reducing the total selenium concentration to 1.0 mg/L. Speciation at this point showed 100% selenate (Se(VI)).

Using one part of the “neutralized” solution, a FeCI₃ reagent was added and the solution passed through a moving bed filter containing 100% silica sand, as shown in FIG. 1 and described at paragraphs 0012-0016 of U.S. patent application Ser. No. 10/727,963. Using a second part of the “neutralized” solution, a FeCI₂ reagent was added and the solution passed through the silica sand filter. Effluent showed a total selenium concentration of 0.98 mg/L+/−0.02 mg/L for both the FeCI₃ reagent and the FeCI₂ reagent, indicating no additional removal of selenium from the solution.

The effluent was then used as influent and passed through a static bed filter containing 60% silica sand and 40% iron granules by volume. Effluent from this second filtering step showed a total selenium concentration of 0.15 mg/L, indicating a 97% removal of selenium from the solution. Speciation of this effluent showed that it contained 100% selenite (Se(IV)), representing a complete reduction of the selenate (Se(VI)) in the influent. Selenate reduction was accomplished via the oxidation of the iron granules with no other reagent addition. The effluent had a pH =5.0. This pH was modified to 7.8 with NaOH with no effect on the selenium concentration. Analysis of the effluent also showed that the lead (Pb) concentration was lowered from 78,000 mg/L to below the minimum detection limit of 0.001 mg/L, and that the cadmium (Cd) concentration was lowered from 0.830 mg/L to below the minimum detection limit of 0.001 mg/L.

### EXAMPLE NO. 2

The same materials and process steps were repeated using a second sample having the same total selenium concentration (5.8 mg/L) as the starting sample used in Example No. 1. After pH neutralization using FeCI₃ and settling the resultant floc, the total selenium concentration had fallen to 0.96 mg/L. Following filtration with a mixture of silica sand and iron granules, as described above, the total selenium concentration was 0.073 mg/L, an improvement over the results in Example No. 1 for similar sample treatment. The sample was then filtered through a layered column of 40:20:40, iron oxide coated sand: limestone: silica sand, by volume. Following filtration with the 40:20:40 layered column, the total selenium concentration was 0.069 mg/L. Lead and cadmium concentrations were lowered from 78,000 mg/L and 0.830 mg/L, respectively, to below their detection limits of 0.001 mg/L.

Modifications to the processes described in Examples 1 and 2 may include one or more of 1) flocculation via pH adjustment and Fe addition to the sample prior to moving bed filtration; 2) using a iron metal/silica sand column to reduce all the Se to selenite and further precipitate and filter out the selenite; or 3) using a layered column to for moving bed filtration followed by in-situ pH neutralization/precipitation and fine particle filtration.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for removing a contaminant from alkaline water, comprising:
adding ferric iron to alkaline water until reaching a pH less than 7 to form a neutralized solution; and
exposing the neutralized solution to iron metal.

2. The method of claim 1, wherein:
adding ferric iron to alkaline water to form a neutralized solution comprises adding ferric iron to a flow of alkaline water; and
exposing the neutralized solution to iron metal comprises flowing the neutralized solution through iron metal.

3. The method of claim 2, wherein:
adding ferric iron to a flow of alkaline water to form a neutralized solution comprises adding ferric iron to a flow of alkaline water to form a first solution having a pH less than 10 and greater than 7, separating solids from the first solution, and adding ferric iron to a flow of the first solution to form a second solution having a pH less than 7 and greater than 3; and
flowing the neutralized solution through iron metal comprises flowing the second solution through iron metal.

4. The method of claim 2, wherein flowing the neutralized solution through iron metal comprises flowing the neutralized solution through iron metal granules.

5. The method of claim 4, wherein flowing the neutralized solution through iron metal granules comprises flowing the neutralized solution through a mixture of sand and iron metal granules.

6. The method of claim 1, wherein:
adding ferric iron to alkaline water to form a neutralized solution comprises mixing ferric iron with alkaline water; and
exposing the neutralized solution to iron metal comprises mixing iron metal with the neutralized solution.

7. The method of claim 6, further comprising separating solids from a solution formed by mixing iron metal with the neutralized solution.

8. The method of claim 7, further comprising separating solids from the neutralized solution before mixing iron metal and the neutralized solution.

9. A method for removing a contaminant from alkaline water, comprising:
neutralizing the alkaline water; and
filtering the neutralized water with iron.

10. The method of claim 9, wherein filtering the neutralized water with iron comprises filtering the neutralized water with iron metal granules.

11. The method of claim 9, wherein filtering the neutralized water with iron comprises filtering the neutralized water with a mixture of sand and iron metal granules.

12. A method for removing selenium from alkaline water, comprising:
neutralizing the water with ferric iron; and
simultaneously reducing ferric iron and selenium oxyanions in the neutralized water.

13. The method of claim 12, wherein neutralizing the water with ferric iron comprises adding ferric iron to the water until reaching a pH less than 7.

14. The method of claim 13, wherein simultaneously reducing ferric iron and selenium oxyanions in the neutralized water comprises exposing the neutralized water to iron metal.

15. A method for removing selenium or a heavy metal from a solution, comprising applying an acidic solution containing ferric iron and selenium or a heavy metal onto solid iron metal.
